(19) United States
(12) Patent Application Publication
(10) Pub. No.: US 2025/0046923 A1
(43) Pub. Date: Feb. 6, 2025

(54) ELECTROCHEMICAL DEVICE, AND MANUFACTURING METHOD FOR SAME

(71) Applicant: Panasonic Intellectual Property Management Co., Ltd., Osaka (JP)

(72) Inventor: TERUHISA MIURA, Kyoto (JP)

(21) Appl. No.: 18/718,526

(22) PCT Filed: Sep. 21, 2022
(86) PCT No.: PCT/JP2022/035255

§ 371 Date: Jun. 11, 2024

(30) Foreign Application Priority Data
Dec. 24, 2021 (JP) 2021-211438

(51) Int. Cl. H01M 50/184; H01M 50/107; H01M 50/186; H01M 50/193

(52) U.S. Cl. CPC H01M 50/184; H01M 50/107; H01M 50/186; H01M 50/193

(57) ABSTRACT

An electrochemical device includes: an electrode assembly including a positive electrode, a negative electrode, and a separator provided between the positive and negative electrodes; a tubular case accommodating the electrode assembly therein and having a bottom closed and an opening; and a gasket sealing the opening of the tubular case. The gasket has a tubular shape with a through-hole. At least one bottom surface of the tubular shape is continuously connected to an outer circumferential side surface of the tubular shape via a tapered surface of the gasket inclining with respect to the outer circumferential side surface. A part of the gasket on the outer circumferential side surface is compressed with a portion of an outer circumference of the tubular case having a diameter locally reduced to constitute a compressed portion. At least a part of the tapered surface is a rough surface having larger surface roughness than the portion of the outer circumferential side surface of the compressed portion.

### TECHNICAL FIELD

The present disclosure relates to an electrochemical device and a method of manufacturing the device.

### BACKGROUND ART

As an electrochemical device represented by a nonaqueous electrolyte battery, a lithium battery of a slim type is disclosed in PTL 1. The lithium battery is obtained by inserting a negative electrode current collector rod and putting organic electrolyte into a positive electrode case in which a positive electrode active material with a cylindrical shape is accommodated, and subsequently inserting a gasket into an opening of the case. A lithium and a separator are wound to form the negative electrode current collector rod. A cylindrical gasket is used to seal the slim type of lithium battery. In a center portion of the gasket, a hole smaller than an outer diameter of the current collector rod by a width ranging from 0.1 mm to 0.3 mm is provided. Further, an outer diameter of the gasket with rubber elasticity is smaller than an inner diameter of the case by a width ranging from.1 mm to 0.3 mm.

### CITATION LIST

### Patent Literature

PTL 1: Japanese Utility Model Laid-Open Publication No. 02-12156

### SUMMARY OF THE INVENTION

The cylindrical gasket described in PTL 1 is manufactured by, e.g., compression-molding a sheet unitarily including a connecting portion and gaskets arranged two-dimensionally connected to one another via the connecting portion. After the molding, the sheet is punched to separate a gasket from the connecting portion. Thus, the gaskets in the sheet are divided into pieces. For instance, the connecting portion located around an outer circumferential side surface of the cylindrical gasket is thinned. The thin connecting portion is pulled and broken by punching. Thus, the gasket is separated from the sheet.

At this moment, a tensile stress is applied to the outer circumferential side surface of the cylindrical gasket to form a broken portion. The broken portion has a rough surface with roughness larger than the other portion, and a protrusion part protruded from the outer circumferential side surface, i.e., a burr may be formed in the breaking portion. When the gasket is inserted into the opening of the case, the breaking portion interferes with an inner side surface of the case, so that the gasket may be hardly inserted into a desired position, or an insertion point of the gasket may be varied. As a result, productivity of the electrochemical device is decreased. Further, sealing performance by the gasket may be deteriorated, so that reliability of the electrochemical device may be decreased.

An electrochemical device in accordance with one aspect of the present disclosure includes: an electrode assembly including a positive electrode, a negative electrode, and a separator provided between the positive electrode and the negative electrode; a tubular case accommodating the electrode assembly therein, the tubular case having a bottom closed and an opening; and a gasket sealing the opening of the tubular case. The gasket has a tubular shape with a through-hole extending along an axis. The gasket has an outer circumferential side surface extending in an axial direction along the axis, a first bottom surface connected to one end of the outer circumferential side surface, and a second bottom surface connected to another end of the outer circumferential side surface. The through-hole has one end opening at the first bottom surface and another end opening at the second bottom side surface. The first bottom surface of the tubular shape is continuously connected to the outer circumferential side surface of the tubular shape via a first tapered surface of the gasket inclining with respect to the outer circumferential side surface. A part of the gasket on the outer circumferential side surface is compressed with a portion of an outer circumference of the tubular case having a diameter locally reduced to constitute a compressed portion. At least a part of the tapered surface is a rough surface having larger surface roughness than the portion of the outer circumferential side surface of the compressed portion.

In a method of manufacturing the electrochemical device in accordance with another aspect of the present disclosure, a gasket having a tubular shape with a through-hole therein is provided. The gasket has a bottom surface of the tubular shape continuously connected to an outer circumferential side surface of the tubular shape via a tapered surface of the gasket inclining with respect to the outer circumferential side surface. One end of the through-hole opens at the bottom surface. A tubular case with a closed bottom is provided. The tubular case has an opening therein. The opening of the tubular case is sealed by inserting the gasket into the opening of the tubular case such that, while the tubular case accommodating the electrode assembly and an electrolyte therein, the bottom surface of the gasket faces the electrode assembly, the electrode assembly including a positive electrode, a negative electrode, and a separator provided between the positive electrode and the negative electrode. In the providing of the gasket, a molded sheet including a connecting portion and a plurality of gaskets including the gasket is provided. The plurality of gaskets are arranged one-dimensionally or two-dimensionally such that the plurality of gaskets are connected to one another via the connecting portion. The connecting portion has a surface continuously connected to the bottom surface of the gasket. The gasket is separated from the molded sheet by breaking the connecting portion such that a broken surface inclining with respect to the outer circumferential side surface is formed.

The present disclosure provides a high-reliable electrochemical device that is excellent in productivity and sealing property when the electrochemical device is sealed with the gasket.

### BRIEF DESCRIPTION OF DRAWINGS

FIG. 1 is a side view and a bottom view of an electrochemical device in accordance with an exemplary embodiment of the present disclosure for schematically showing a structure of a gasket used in the device.

FIG. 2 is a cross-sectional view of a molded sheet for manufacturing the gasket shown in FIG. 1.

FIG. 3 is a side view of another gasket used in the electrochemical device in accordance with the embodiment of the present disclosure.

FIG. 4 is a front view of a partially cross-sectioned electrochemical device in accordance with the embodiment of the present disclosure.

### DESCRIPTION OF EMBODIMENTS

An electrochemical device in accordance with an exemplary embodiment of the present disclosure includes: an electrode assembly including a positive electrode, a negative electrode, and a separator provided between the positive and negative electrodes; a tubular case with a bottom accommodating the electrode assembly therein; and a gasket sealing an opening of the tubular case.

In the present disclosure, the electrochemical device includes a battery, such as a rechargeable lithium-ion battery or a lithium primary battery, and a capacitor, such as a lithium ion capacitor or an electric double layer capacitor. Each of a positive electrode and a negative electrode of the electrochemical device may be a polarizable electrode or a nonpolarizable electrode. The positive electrode and/or the negative electrode may be a polarizable electrode in which an ion is adsorbed to an active material to form an electric double layer, thereby exhibiting capacity. Alternatively, the positive electrode and/or the negative electrode may be a nonpolarizable electrode in which a lithium ion is occluded and discharged reversibly, i.e., a Faraday reaction is proceeded, thereby exhibiting capacity. The electrochemical device may exhibit capacity by occluding and/or discharging a lithium ion, or may exhibit capacity by adsorbing and desorbing a lithium ion to and from an active material or chemically interacting between the lithium ion and the active material.

The gasket has a tubular shape with a through-hole therein extending along an axis. The gasket has an outer circumferential side surface and two bottom surfaces. The bottom surfaces are opposite to each other via the outer circumferential side surface and a tapered surface of the gasket. A first bottom surface on one side of the tubular shape is continuously connected to the outer circumferential side surface of the tubular shape via the tapered surface of the gasket inclining with respect to the outer circumferential side surface.

By reducing a diameter of a portion of the tubular case on an outer circumference surface of the tubular case, a part of the gasket along the outer circumferential side surface is compressed, thereby forming a compressed portion. A sealing property between the gasket and the tubular case is secured by a repulsive force of the gasket in the compressed portion.

At least a part of the tapered surface is a rough surface with a larger surface roughness than the outer circumferential side surface of the compressed portion. For instance, the region including a larger roughness than the outer circumferential side surface is located in the tapered surface and includes a broken surface. The broken surface is formed, e.g., when a molded sheet is punched to provide an individual gasket. In the molded sheet, plural gaskets are arranged one-dimensionally or two-dimensionally. A tensile stress is applied to a connecting portion connecting the gaskets to one another in the molded sheet to break the connecting portion, thereby forming the broken surface. By breaking the connecting portion, the broken surface may be formed in the tapered surface.

Similarly to the first bottom surface on the one side, a second bottom surface on the other side of the tubular shape may be continuously connected to the outer circumferential side surface via a second tapered surface of the gasket inclining with respect to the outer circumferential side surface. In the first bottom surface on the one side and/or the second bottom surface on the other side, an annular projecting portion extending to surround the through-hole and/or an uneven surface may be provided.

Functions of the second tapered surface, the projecting portion, and the uneven surface will be described later.

In the electrochemical device in accordance with the embodiment of the present disclosure, since being formed in the tapered surface of the gasket, the broken surface is prevented from interfering with an inner side surface of the tubular case when the gasket is inserted into the opening of the tubular case to seal the tubular case. This configuration allows the tubular case to be securely sealed with the gasket, thereby enhancing the productivity dramatically. Further, since the gasket is inserted and fixed at a desired position accurately, sealing performance by the gasket is kept high, so that high reliability of the electrochemical device can be maintained.

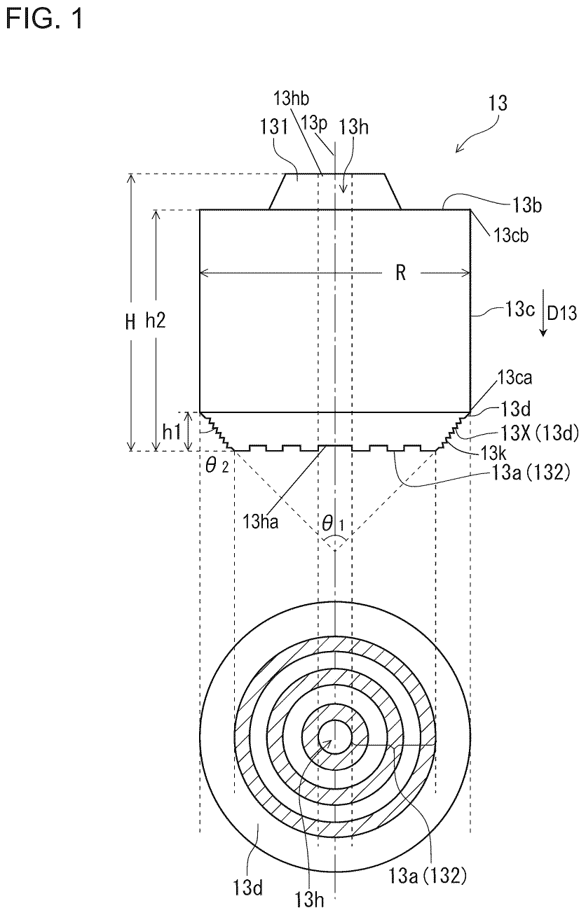

FIG. 1 shows the electrochemical device in accordance with the embodiment of the present disclosure for showing gasket 13. A side view of FIG. 1 is viewed from a direction of a side surface of gasket 13. A bottom view of FIG. 1 is viewed from bottom surface 13a (bottom surface having tapered surface 13d) on one side of gasket 13.

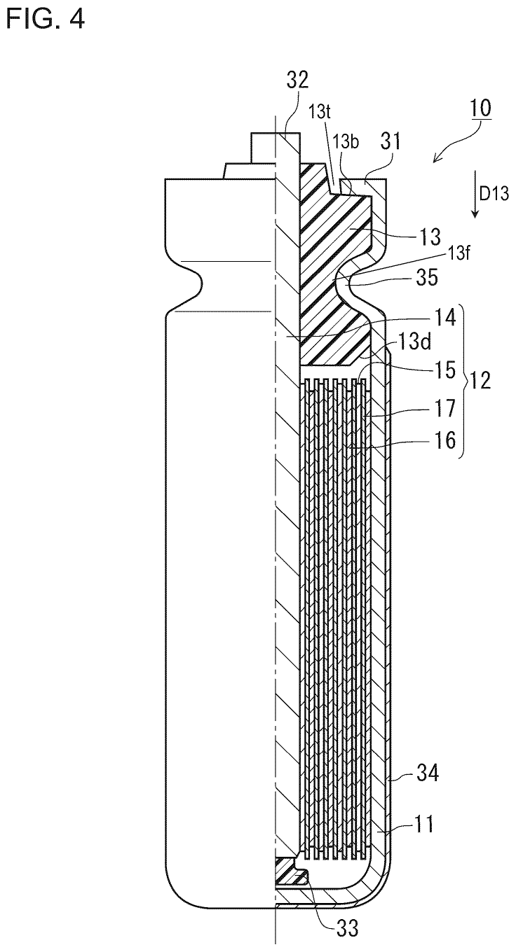

Gasket 13 shown in FIG. 1 has a tubular shape with through-hole 13h extending along axis 13p in the center portion. Through-hole 13h is closed by current collector rod 14 (see FIG. 4). The current collector rod is inserted into through-hole 13h so as to expose its one end to the outside, thereby functioning as an external terminal. Axis 13p extends in axial direction D13.

Gasket 13 has bottom surfaces 13a and 13b of the tubular shape and outer circumferential side surface 13c connects bottom surface 13a and bottom surface 13b to each other. Bottom surface 13a is continuously connected to outer circumferential side surface 13c via tapered surface 13d of the gasket. Region 13X which serves as at least a part of tapered surface 13d is broken surface 13k formed by separating the gasket from a molded sheet. Region 13X has a larger surface roughness (arithmetic average roughness) than outer circumferential side surface 13c in compressed portion 13f contacting portion 35 with a locally reduced diameter (see FIG. 4). Bottom surface 13a is connected to one end 13ca of outer circumferential side surface 13c in axial direction D13, and one end 13ha of through-hole 13h is opened. Bottom surface 13b is connected to other end 13ca of outer circumferential side surface 13c in axial direction D13, and other end 13ha of through-hole 13h is opened.

Annular projecting portion 131 extending to surround through-hole 13h is provided on bottom surface 13b of gasket 13. In FIG. 1, annular projecting portion 131 has an outer circumferential surface tapered to bottom surface 13b. However, projecting portion 131 may have an outer circumferential surface perpendicular to bottom surface 13b.

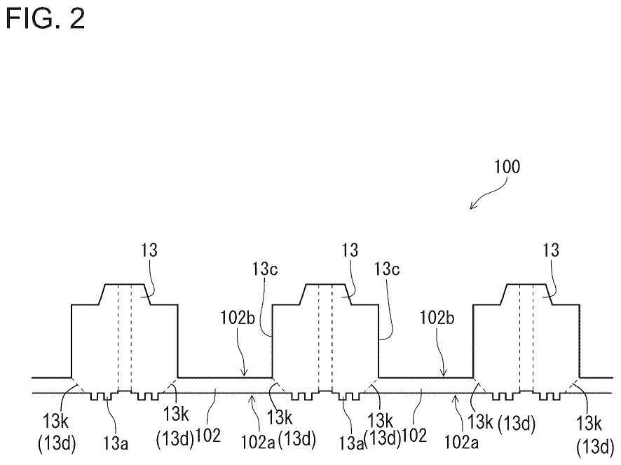

FIG. 2 is a cross-sectional view of molded sheet 100 before gasket 13 shown in FIG. 1 is separated. In FIG. 2, in molded sheet 100, plural gaskets 13 are connected to one another one-dimensionally or two-dimensionally via connecting portion 102, and plural gaskets 13 and connecting portion 102 constitute one sheet as a whole. Molded sheet 100 is manufactured by compression molding, for example.

Connecting portion 102 is a plate or a film that has two main surfaces 102a and 102b opposite to each other. However, a space between gaskets 13 may not necessarily be filled with connecting portion 102 completely. An area filled with nothing (e.g., through-hole) may be formed in molded sheet 100. The area may be located in the plurality of gaskets 13 or connecting portion 102.

One main surface 102a of connecting portion 102 is continuously connected to bottom surface 13a of gasket 13. Another main surface 102b of connecting portion 102 is continuously connected to an end of outer circumferential side surface 13c of gasket 13 facing a bottom surface 13a. In molded sheet 100, when gasket 13 is separated from the connecting portion, a broken surface inclining with respect to bottom surface 13a and outer circumferential side surface 13c is formed, so that tapered surface 13d is formed.

If a force is applied to molded sheet 100 from bottom surface 13a in a direction perpendicular to bottom surface 13a, connecting portion 102 receives a tensile stress to be broken, thereby punching gasket 13 from molded sheet 100 so as to separate gasket 13. At this moment, gasket 13 is punched such that broken surface 13k inclining with respect to bottom surface 13a and outer circumferential side surface 13c is formed, thereby providing gasket 13 with a broken surface formed in a part of tapered surface 13d.

Outer circumferential side surface 13c in compressed portion 13f contacting reduced-diameter portion 35 (see FIG. 4) has a surface roughness (arithmetic average roughness) Ra of, e.g, 0.006 mm or less. On the other hand, tapered surface 13d which is broken surface 13k has a surface roughness (arithmetic average roughness) Ra more than 0.006 mm. For instance, surface roughness Ra may be more than or equal to 0.009 mm, or more than or equal to 0.015 mm.

Axial direction D13 along axis 13p is defined as a direction from bottom surface 13a on one side toward bottom surface 13b on the other side of the tubular shape. The maximum height of tapered surface 13d in axial direction D13 with respect to bottom surface 13a on one side of the tubular shape is h1. A height of outer circumferential side surface 13c from bottom surface 13a to end 13cb on a bottom surface 13b side, which is located on the other side, in axial direction D13 is h2. Ratio h1/h2 of height h1 to height h2 may range from 0.04 to 0.43. Ratio h1/h2 more than or equal to 0.04 allows connecting portion 102 to be sufficiently thick in molded sheet 100. This configuration facilitates peeling off molded sheet 100 from a mold for molding, thereby enhancing the productivity. On the other hand, ratio h1/h2 less than or equal to 0.43 prevents the tapered surface of the gasket from overlapping the reduced-diameter portion of tubular case 11, so that stable sealing performance may be maintained easily. If a second tapered surface of the gasket, described later, is formed between bottom surface 13b and outer circumferential side surface 13c, a height of the second tapered surface is taken in account.

Ratio h2/R of height h2 to outer diameter R of outer circumferential side surface 13c may be more than or equal to 0.18 and less than or equal to 1.6, or may be more than or equal to 0.23 and less than or equal to 1.6. As ratio h2/R is smaller, a thickness (height in axial direction D13) of the gasket decreases with respect to outer diameter R, and a volume occupied by the gasket becomes smaller with respect to tubular case 11. This configuration increases a charging amount of electrolytic solution or an amount of electrode active material, so that high capacity may be obtained easily. On the other hand, as ratio h2/R is greater, sealing property by the gasket may be more enhanced. This configuration provides high sealing pressure resistance, thereby enhancing reliability of the electrochemical device. Ratio h2/R in the range from 0.18 or more to 1.6 or less provides high capacity and high reliability both easily simultaneously. High reliability depends on high sealing property of the gasket.

During the usage of the electrochemical device, a pressure inside the tubular case may increase. If a swelling which has a certain volume or more occurs in the gasket due to the increase of inner pressure, a repulsive force applied to an inner side surface of the tubular case from the gasket may decrease, thereby deteriorating the sealing property. For this reason, the gasket preferably has a structure that can suppress the swelling due to the increase of inner pressure, or is constituted by a material that can suppress the swelling. Ratio h2/R is more preferable to have a large value, in the viewpoint of suppressing a swelling of the gasket due to the increase of inner pressure.

Further, as ratio h2/R is larger, an allowable variation range can be more widened for a height position of the reduced-diameter portion. This configuration enhances productivity of the product. Ratio h2/R of the gasket less than or equal to 1.6 provides sufficient deformation resistance with respect to the inner pressure in usual use conditions.

For instance, a rubber material may be used for the gasket. A butyl rubber or the like used as the rubber material of the gasket provides a stable sealing repulsive force, thereby enhancing sealing property. On the other hand, the rubber material easily deforms due to an increase of the inner pressure. When ratio h2/R is less than 0.23, if a rubber material whose Young's modulus is substantially 0.05 GPa or less is used, the rigidity is likely to be insufficient from a viewpoint of swelling suppression. In this case, the gasket may be constituted by a laminated structure having at least two layers, i.e., a rubber material layer (e.g., butyl rubber layer) and a fluororesin layer. This structure enhances the rigidity of the gasket, so that high sealing repulsive force may be obtained and a swelling of the gasket can be suppressed simultaneously. Note that, Young's modulus of fluororesin may be more than or equal to 0.4 GPa as a general value.

More specifically, in the electrochemical device including a tubular case whose outer diameter (diameter) is 6.4 mm, a gasket with height h2 of 1.2 mm, outer diameter R of 6.6 mm (unloaded condition), and ratio h2/R of 0.18 can be used. In this case, a fluororesin layer with height of 0.7 mm and a rubber material layer with height of 0.5 mm can be used, thereby reducing a height of the gasket to less than 1.5 mm. This configuration increases an internal volume of the electrochemical device, so that a charging amount of electrolytic solution which is accommodated in the case, and an amount of electrode active material can be increased as compared with the conventional structure. Therefore, a high-capacity and high-reliable electrochemical device can be provided. Further, a gap inside the tubular case, except for the charging amount of electrolytic solution and the amount of electrode active material, can be increased. This enhances reflow resistance and maintains the properties for a long period of time.

An outer diameter of the gasket may be larger than an outer diameter of the tubular case. In this case, when the gasket is press-fitted into the tubular case, adhesion between an outer side surface of the fluororesin layer of the gasket and an inner side surface of the tubular case is improved. Further, adhesion between a rubber material layer which has the same diameter of the fluororesin layer and the inner side surface of the tubular case also be increased. Thus, the electrolytic solution is prevented from leaking out from a gap between the inner side surface of the tubular case and the outer side surface of the gasket, thereby improving the productivity. Further, the reduced-diameter portion formed in the tubular case reduces an amount of diameter reduction.

Note that, when the gasket has the laminated structure having at least two layers, i.e., a rubber material layer and a fluororesin layer, tapered surface 13d is formed in the rubber material layer. Further, compressed portion 13f contacting reduced-diameter portion 35 (see FIG. 4) of the tubular case is formed in the rubber material layer.

When ratio h2/R is more than or equal to 0.23, even gasket 13 constituted by only a rubber material maintains deformation resistance to the inner pressure. Thus, a high-reliable electrochemical device can be provided using cheaper gasket parts.

Taper angle θ1 of tapered surface 13d is, e.g., more than or equal to 4.6° and less than 90°. Angle θ1 more than or equal to 4.6° sufficiently prevents a burr portion formed in broken surface 13k from projecting further than outer circumferential side surface 13c and interfering with the inner side surface of the tubular case, when the gasket is inserted into the opening of the tubular case. Angle θ2 formed by tapered surface 13d and outer circumferential side surface 13c (axial direction D13) may be more than or equal to 2.3° and less than or equal to 45°.

In FIG. 1, annular projecting portion 131 which extends to surround through-hole 13h is formed on bottom surface 13b of gasket 13. In gasket 13, projecting portion 131 is provided on a bottom surface (i.e., bottom surface on an opposite side to tapered surface 13d via outer circumferential side surface 13c) on a side not facing the electrode assembly. Projecting portion 131 prevents a leakage current from flowing between the current collector rod which closes through-hole 13h, and the tubular case via water drops or the like, which adhere to the bottom surface.

In the electrochemical device, reduced-diameter portion 35 is formed in a portion of an outer circumference of tubular case 11, thereby compressing gasket 13 locally, so that the opening of tubular case 11 is sealed. Further, curl portion 31 is formed at an end on an opening side of tubular case 11 (see FIG. 4). At this time, if bottom surface 13b is flat, a step is formed between bottom surface 13b and curl portion 31 which is formed along bottom surface 13b. Thus, recess 13t is likely to be formed in bottom surface 13b. Bottom surface 13b is a surface located on the side not facing the electrode assembly. If water drops or the like adhere to recess 13t, current collector rod end 32 and curl portion 31 of tubular case 11 is short-circuited via the water drops or the like, thus allowing leakage current to flow between current collector rod end 32 and curl portion 31. Projecting portion 131 provided on bottom surface 13b prevents the leakage current from flowing between current collector rod end 32 and curl portion 31 of tubular case 11 via the water drops or the like even if the curl portion is formed in the end on an opening side of tubular case 11.

A projection surface of annular projecting portion 131 has an outer diameter 0.39 times or more and 0.86 times or less outer diameter R of outer circumferential side surface 13c, for example. If the projection surface of projecting portion 131 has an outer diameter 0.39 times or more outer diameter R, a thickness of projecting portion 131 in a radial direction can be secured sufficiently, so that the molding is made easy. If the projection surface has an outer diameter 0.86 times or less outer diameter R, high ability of holding a gasket position can be maintained with respect to inner pressure of the tubular case in normal use conditions, thereby making it possible to achieve high sealing reliability.

Projecting portion 131 prevents leakage current from flowing between current collector rod end 32 and curl portion 31 of tubular case 11. This configuration extends curl portion 31 inwardly toward an outer circumferential side surface of projecting portion 131, reducing an aperture ratio accordingly. The aperture ratio is obtained by dividing an inner diameter of a tip end of the curl portion by an outer diameter of the tubular case. Thus, moisture intrusion from the outside can be prevented, so that long-term reliability of the electrochemical device can be improved. Further, a swelling of the gasket can be prevented from occurring in an opening surface of a product case during reflow.

More specifically, in the case that outer diameter R of outer circumferential side surface 13c is 3.6 mm and an inner diameter of through-hole 13h is 1 mm, the gasket is molded easily, and high productivity can be maintained easily. Therefore, the thickness of projecting portion 131 in a radial direction is preferably more than or equal to 0.2 mm. Accordingly, in this case, the projection surface of projecting portion 131 has preferably an outer diameter (diameter) of 1.4 mm or more, and the outer diameter is preferably 0.39 times or more outer diameter R of outer circumferential side surface 13c. In this case, the inner diameter of the tip end of the curl portion can be decreased to 1.5 mm, and the aperture ratio can be reduced by 40% or more, as compared with the conventional structure. As for the conventional structure, an inner diameter of a tip end of the curl portion is 2.6 mm, and an outer diameter of the tubular case is 4.5 mm.

The outer circumferential side surface of annular projecting portion 131 may be perpendicular to bottom surface 13b, but preferably has a tapered shape, i.e., the projection surface of projecting portion 131 may have an outer diameter smaller than an outer diameter on a bottom surface 13b side of projecting portion 131, as shown in FIG. 1. In this case, if molded sheet 100 shown in FIG. 2 is formed by compression molding, a mold-release property is enhanced in taking out molded sheet 100 from a mold. As a result, productivity of the gasket is improved, thereby providing inexpensive electrochemical devices.

An uneven surface or a matte surface may be formed in at least one side of the bottom surfaces of the tubular shape of the gasket. In the side view and the bottom view of FIG. 1, uneven surface 132 is concentrically formed about through-hole 13h on bottom surface 13a of gasket 13. Gasket 13 may often have adhesiveness. In the case where gaskets 13 are supplied to a supply machine to seal the tubular case, even if gaskets 13 contact one another in the supply machine, uneven surface 132 may reduce the contact area therebetween, thereby preventing gaskets 13 from sticking to one another. Thus, handling of the gaskets is made easy, thereby improving productivity dramatically.

Uneven surface 132 may be formed in bottom surface 13b. In the case that projecting portion 131 is formed on bottom surface 13b, the projection surface of projecting portion 131 may be formed in uneven surface 132.

Uneven surface 132 may function to restrictedly position a breaking position at a recess in uneven surface 132. The breaking position is a position at which molded sheet 100 is punched to form tapered surface 13d. In this case, tapered surface 13d is formed so as to be continuously connected to the recess in uneven surface 132. This configuration enhances roundness of an outer circumference of bottom surface 13a.

A height of the center of gravity of gasket 13 from bottom surface 13a in axial direction D13 may range from 0.45·H to 0.498·H, where H is a maximum distance between one bottom surface 13a and another bottom surface 13b of gasket 13. In this case, when the gasket vibrates at a particular frequency, amplitude of vibrations on bottom surfaces 13a and 13b are different from each other. This configuration allows to control the gaskets such that each gasket turns to the same direction (e.g., direction in which bottom surface 13b faces upward) when the gaskets are conveyed. Thus, the productivity is improved drastically. The height of the center of gravity of gasket 23 from bottom surface 13a more preferably ranges from 0.46·H to 0.49·H.

In present disclosure, maximum distance H, maximum height h1, and height h2 of gasket 23 are defined as a dimension of gasket 23 in an unloaded state, i.e., the state where the gasket is taken out of the electrochemical device but not yet inserted into tubular case 11.

In the case that projecting portion 131 is formed on bottom surface 13b and/or uneven surface 132 is formed in bottom surface 13a, projecting portion 131 and uneven surface 132 are taken into account to determine maximum distance H. In other word, when gasket 13 is disposed on a reference plane while bottom surface 13a faces downward, maximum distance H is the maximum height of gasket 13 from the reference plane.

Maximum height h1 and height h2 mentioned above are determined as follows. In the case that projecting portion 131 is formed on bottom surface 13a, when gasket 13 is disposed on a reference plane while bottom surface 13a faces downward, maximum height h1 is obtained by subtracting a height of projecting portion 131 from the maximum height of tapered surface 13d from the reference plane, and height h2 is obtained by subtracting the height of projecting portion 131 from a height of outer circumferential side surface 13c from the reference plane (a height of second tapered surface 13e from the reference surface when the gasket has second tapered surface 13e). Height h2 means a distance from one bottom surface 13a to another bottom surface 13b.

In the case that tapered surface 13d is provided, the center of gravity of gasket 13 is shifted toward bottom surface 13b. In order to position the center of gravity of the gasket in the range from 0.45·H to 0.498·H from bottom surface 13a, projecting portion 131 may be formed on bottom surface 13b. Gasket 13 has a multilayer structure including plural material layers laminated in axial direction D13 of gasket 13. A material layer out of the plural material layers having a higher density may be disposed in bottom surface 13a.

In addition to tapered surface 13d provided on a bottom surface 13a side, another tapered surface may be provided in bottom surface 13b of gasket 13. In other word, the bottom surface on the other side of the tubular shape may be continuously connected to the outer circumferential side surface of the tubular shape via a second tapered surface inclining with respect to the outer circumferential side surface. The second tapered surface may have an optional tilt angle according to a mold used in molding. Therefore, surface roughness of the second tapered surface is equal to surface roughness of the outer circumferential side surface in the reduced-diameter portion.

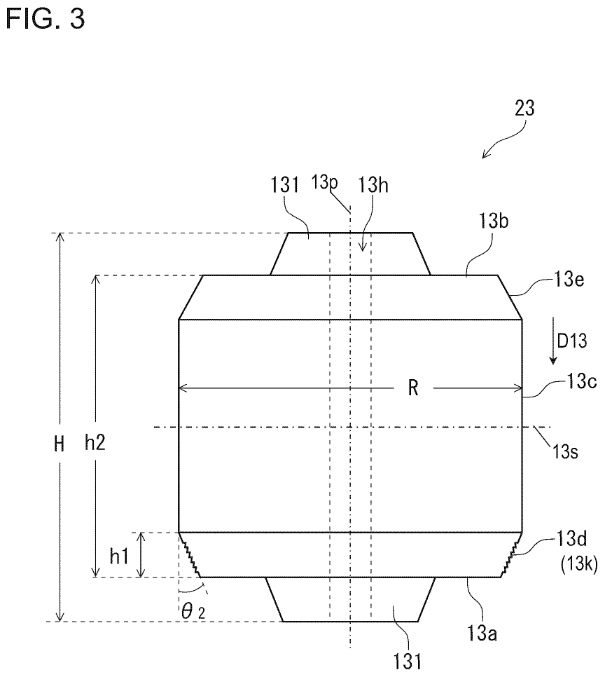

FIG. 3 is a schematic side view of gasket 23 having second tapered surface 13e continuously connected to bottom surface 13b and outer circumferential side surface 13c. In the example of FIG. 3, annular projecting portions 131 extending to surround through-hole 13h are provided in both bottom surfaces 13a and 13b of gasket 23. An uneven surface or a matte surface may be formed in the projection surface of projecting portion 131. An angle formed by outer circumferential side surface 13c and second tapered surface 13e is substantially the same as angle θ2 formed by outer circumferential side surface 13c and tapered surface 13d. Heights of two projecting portions 131 formed on bottom surface 13a and bottom surface 13b are substantially identical to each other. Thus, the entire shape of gasket 13 is symmetrical about plane 13s perpendicular to axis 13p of the tubular shape except for a difference in surface roughness between tapered surface 13d and second tapered surface 13e.

In this case, directions of gaskets 23 may not necessarily be aligned when gasket 23 is conveyed to an opening end of tubular case 11. For instance, in FIG. 3, gasket 23 may be conveyed while bottom surface 13a faces upward, or gasket 23 may be conveyed while bottom surface 13b faces upward. Gasket 23 may be inserted into tubular case 11 such that bottom surface 13a faces the electrode assembly. Alternatively, gasket 23 may be inserted into tubular case such that bottom surface 13b faces the electrode assembly. Even in either case, the gasket is inserted into and fixed to the opening end of the tubular case accurately. Thus, the same sealing performance is obtained, thereby improving the productivity.

The electrochemical device may include an electrode assembly of a wound type. In the electrode assembly of the wound type, a positive electrode with a belt shape and a negative electrode with a belt shape are wound spirally via a separator between the electrode. Alternatively, the electrochemical device may include an electrode assembly of a monolayer type or a lamination type. In the electrode assembly of the monolayer type or the lamination type, a positive electrode with a belt shape and a negative electrode with a belt shape are laminated via a separator between the electrodes. In the case that the structure of the present disclosure is applied to a cylindrical electrochemical device, a ratio of the outer diameter and the height may not necessarily be specified.

In the electrode assembly, one of the positive electrode and the negative electrode is electrically connected to the current collector rod which serves as a charge collector that has a stick or rod shape. The current collector rod fills the through-hole of the gasket while exposing an end of the rod to the outside. The end of the current collector rod exposed to the outside functions as an external terminal. In the electrode assembly, the other of the positive electrode and the negative electrode may be electrically connected to the tubular case. In this case, one of the current collector rod and the tubular case constitutes a positive electrode outside terminal, and the other thereof constitutes a negative electrode external terminal.

Plural through-holes (e.g., two through-holes) may be formed in the gasket. In this case, plural current collector rods of which number is the same as the through-holes are provided. Each of the current collector rods closes a corresponding one of the through-holes, and respective ends of the rods are exposed to the outside of the electrode assembly. One or more current collector rods out of the plural current collector rods are electrically connected to one of the positive electrode and the negative electrode of the electrode assembly. Other one or more current collector rods are electrically connected to the other of the positive electrode and the negative electrode of the electrode assembly. In this case, the one or more current collector rods out of among the plural current collector rods electrically connected to the positive electrode constitute a positive electrode outside terminal, and the one or more current collector rods electrically connected to the negative electrode constitute a negative electrode outside terminal.

A method of manufacturing the electrochemical device in accordance with the embodiment of the present disclosure includes: a step (i) of providing a gasket having a tubular shape with a through-hole therein, the gasket having a first bottom surface of the tubular shape continuously connected to an outer circumferential side surface of the tubular shape via a tapered surface of the gasket inclining with respect to the outer circumferential side surface, one end of the through-hole opening at the first bottom surface; a step (ii) of providing a tubular case with a bottom; and a step (iii) of sealing an opening of the tubular case by inserting the gasket into the opening of the tubular case such that, while the tubular case accommodating the electrode assembly and an electrolyte therein, the bottom surface of the gasket faces the electrode assembly, the electrode assembly including a positive electrode, a negative electrode, and a separator provided between the positive electrode and the negative electrode. The step (ii) of providing the gasket includes: a step of providing a molded sheet including a connecting portion and a plurality of gaskets including the gasket, the plurality of gaskets being arranged one-dimensionally or two-dimensionally such that the plurality of gaskets are connected to one another via the connecting portion, the connecting portion having a surface continuously connected to the bottom surface of the gasket; and a step of separating the gasket from the molded sheet by breaking the connecting portion such that a broken surface 13k inclining with respect to the outer circumferential side surface is formed.

A pin type of cylindrical lithium primary battery is given as an example, and each component of the electrochemical device in accordance with the embodiment of the present disclosure will be detailed below.

### Positive Electrode

A positive electrode may include a positive electrode mixture layer (positive active material layer) and a positive electrode current collector holding the positive electrode mixture layer. The positive electrode mixture layer contains a positive electrode active material, and further contains a conducting agent, a binder, and the like, as necessary. The positive electrode current collector is, e.g., a metallic foil, and has a strip which is suitable to be wound. A material of the positive electrode current collector is not limited to this, but may be aluminum, aluminum alloy, or the like.

The positive electrode current collector may contain an expanded metal. In this case, a positive electrode mixture of a wet state is pressurized in a thickness direction so as to fill a mesh in the expanded metal and dried, thereby providing the positive electrode.

The positive electrode mixture of a wet state is prepared by mixing electrode active material, additives such as a conductive material and a binder, and a proper quantity of water, for example.

As the positive electrode active material contained in the positive electrode, a manganese dioxide is employed. The positive electrode which contains a manganese dioxide is excellent in pulse discharge characteristics since exhibiting a relatively high voltage. The manganese dioxide may be of a mixed crystal state containing two or more kinds of crystal states. The positive electrode may contain a manganese oxide other than the manganese dioxide. As the manganese oxide other than the manganese dioxide, MnO, Mn₃O₄, Mn₂O₃, Mn₂O₇, and the like may be employed. A main component of the manganese oxide which is contained in the positive electrode is preferably manganese dioxide.

Lithium may be partially doped in the manganese dioxide contained in the positive electrode. If an amount of the doped lithium is a little, high capacity will be secured. A manganese dioxide and a manganese dioxide in which a small amount of lithium is doped may be expressed as LiₓMnO₂ (0≤x≤0.05). An average composition of the entire manganese oxide contained in the positive electrode may be LiₓMnO₂ (0≤x≤0.05). Ratio x of Li may be less than or equal to 0.05 in an initial discharge state of a lithium primary battery. Typically, ratio x of Li increases as electric discharge of the lithium primary battery progresses. An oxidation number of manganese contained in the manganese dioxide is a valence of 4, theoretically. However, in the case that another manganese oxide is contained in the positive electrode or lithium is doped in the manganese dioxide, an oxidation number of manganese is likely to be smaller than a valence of 4. Therefore, in LiₓMnO₂, an average oxidation number of manganese is smaller than a valence of 4.

The positive electrode can contain another positive electrode active material used in a lithium primary battery. As another positive electrode active material, graphite fluoride or the like is employed. The percentage of LiₓMnO₂ in the entire positive electrode active material may be 90% by mass or more.

As the manganese dioxide, an electrolysis manganese dioxide is suitably used. An electrolysis manganese dioxide subjected to at least any of neutralization processing, washing processing, and firing treatment may be used, as necessary. Typically, an electrolysis manganese dioxide is obtained by electrolyzing manganese sulfate solution.

The positive electrode may contain another positive electrode active material used in a lithium primary battery. For instance, the positive electrode containing graphite fluoride maintains the performance at higher temperatures, thus providing a lithium primary battery with excellent long term reliability.

As the binder, a fluororesin, a rubber particle, and an acrylic resin are employed, for example.

As the conductive material, a conductive carbon material is employed, for example. As the conductive carbon material, natural graphite, artificial graphite, carbon black, and carbon fiber are employed, for example.

### Negative Electrode

The negative electrode may contain metal lithium or a lithium alloy, or may contain both metal lithium and a lithium alloy. For instance, a compound containing metal lithium and a lithium alloy may be used for the negative electrode.

As the lithium alloy, a Li—Al alloy, a Li—Sn alloy, a Li—Ni—Si alloy, a Li—Pb alloy, and the like are employed. From a viewpoint of securing electric discharge capacity or stabilizing internal resistance, a content of metallic element contained in the lithium alloy, except for lithium, preferably ranges from 0.05% by mass to 15% by mass.

Metal lithium, a lithium alloy, and a compound of these are molded to have an optional shape and a thickness, depending on a shape, a dimension, standard performance, or the like of a lithium primary battery.

A sheet of metal lithium, a lithium alloy, or a compound of these may be used for the negative electrode. The sheet is obtained by extrusion molding, for example. More specifically, in a cylindrical battery, a foil or the like of metal lithium or a lithium alloy is used. The foil or the like has a longitudinal direction and a lateral direction.

In a cylindrical battery, an elongated tape may be stuck on at least one main surface of the negative electrode. A resin base material and an adhesive layer are provided on the elongated tape along the longitudinal direction. The main surface of the negative electrode is a surface of the negative electrode facing the positive electrode. A width of this tape may be, e.g., 0.5 mm or more and 3 mm or less. This tape prevents current collection failure due to foil cutting when a lithium component of the negative electrode is consumed by a reaction in the end of electric discharge.

As a material of the resin base material, polyolefin, polyethylene terephthalate, and the like can be used, for example. The polyolefin includes fluororesin, polyimide, polyphenylene sulfide, polyether sulfone, polyethylene, and polypropylene. Especially, polyolefin is preferable, and polypropylene is more preferable.

The adhesive layer contains at least one component selected from the group consisting of, e.g., rubber component, silicone component, and acrylic resin component. Specifically, a synthetic rubber and a natural rubber may be used as the rubber component. As the synthetic rubber, a butyl rubber, a butadiene rubber, a styrene butadiene rubber, an isoprene rubber, neoprene, polyisobutylene, an acrylonitrile butadiene rubber, a styrene isoprene block copolymer, a styrene butadiene block copolymer, a styrene ethylene butadiene block copolymer, and the like are employed. As the silicone component, an organic compound having a polysiloxane structure, a silicone-based polymer, and the like can be used. As the silicon-based polymer, peroxide curable-type silicone, addition reaction-type silicone, and the like are employed. As the acrylic resin component, a polymer containing acrylic monomers such as acrylic acid, methacrylic acid, acrylic acid ester, and methacrylic acid ester can be used, and a homo- or copolymer of acrylic monomer, such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate, or the like are employed. Note that, a crosslinking agent, a plasticizer, and a tackifier may be contained in the adhesive layer.

### Electrolyte

Nonaqueous electrolytic solution may be used for electrolyte (nonaqueous electrolyte), for example. The nonaqueous electrolytic solution is obtained by dissolving lithium salt or lithium ion in nonaqueous solvent.

### Nonaqueous Solvent

As the nonaqueous solvent, an organic solvent is employed. Typically, the organic solvent may be used for nonaqueous electrolytic solution of a lithium primary battery. As the nonaqueous solvent, ether, ester, carbonic ester, and the like are employed. As the nonaqueous solvent, dimethyl ether, γ-butyrolactone, propylene carbonate, ethylene carbonate, 1,2-dimethoxyethane, and the like can be used. The nonaqueous electrolytic solution may contain one kind of nonaqueous solvent, or may contain two or more kinds of nonaqueous solvents.

From a viewpoint of improving discharge characteristics of a lithium primary battery, the nonaqueous solvent preferably contains cyclic carbonate ester and a chain ether. The cyclic carbonate ester has a high boiling point, and the chain ether has a low viscosity even under low temperatures. The cyclic carbonite ester preferably contains at least one selected from the group consisting of propylene carbonate (PC) and ethylene carbonate (EC). The PC is particularly preferable. The chain ether preferably has a viscosity of 1 mPa·s or less at 25° C. Especially, dimethoxyethane (DME) is preferably contained therein. Micro sample viscometer m-VROC manufactured by Rheosense Co. is used to measure viscosity of the nonaqueous solvent under a temperature of 25° C. and at a shear rate of 10000 (1−/s).

A form of the electrolyte is not limited to a liquid, but may be a gel or a solid (polymeric solid electrolyte).

### Lithium Salt

The nonaqueous electrolytic solution may contain lithium salt other than annular imide component. As the above mentioned lithium salt, lithium salt used in a lithium primary battery as a solute is employed, for example. As such lithium salt, LiCF₃SO₃, LiN(CF₃SO₂)₂, LiClO₄, LiBF₄, LiPF₆, LiRaSO₃ (Ra is a fluorinated alkyl group with a carbon number of 1 to 4), LiFSO₃, LiN (SO₂Rb) (SO₂Rc) (Rb and Rc each are a fluorinated alkyl group with a carbon number of 1 to 4, independently), LiN(FSO₂)₂, LiPO₂F₂, LiB(C₂O₄)₂, and LiBF₂ (C₂O₄) are employed, for example. The nonaqueous electrolytic solution may contain one kind of lithium salt, or may contain two or more kinds of these lithium salts.

The concentration (total concentration of lithium salts) of lithium ions contained in the electrolytic solution may range, e.g., from 0.2 mol/L to 2.0 mol/L, or may range from 0.3 mol/L to 1.5 mol/L.

The electrolytic solution may contain additional agent, as necessary. As such additional agent, propane sultone, vinylene carbonate, and the like are employed. A total concentration of such additional agents contained in a nonaqueous electrolytic solution ranges, e.g., from 0.003 mol/L to 5 mol/L.

### Separator

A lithium primary battery often includes a separator provided between positive and negative electrodes. As the separator, a porous sheet may be used. The porous sheet is made of insulating material, and has resistance to an internal environment of the lithium primary battery. Specifically, a nonwoven fabric made of a synthetic resin, a microporous membrane made of a synthetic resin, a laminated body of these, or the like is employed.

As the synthetic resin used for the nonwoven fabric, polypropylene, polyphenylene sulfide, poly butylene terephthalate, and the like are employed, for example. As the synthetic resin used for the microporous membrane, a polyolefin resin and the like are employed, for example. The polyolefin resin includes polyethylene, polypropylene, and an ethylene-propylene copolymer. The microporous membrane may contain inorganic particles, as necessary.

The thickness of the separator may be, e.g., more than or equal to 5 μm and less than or equal to 100 μm. The separator may be a single layer film including one material, or may be a composite film or a multilayer film including two or more materials.

### Gasket

The material of the gasket is not particularly limited, but may be selected appropriately in consideration of stability for the electrolyte or heat resistance. Specifically, polypropylene, polyethylene, polyphenylene sulfide, polyether ketone, polyamide, polyimide, a liquid crystal polymer, a perfluoroalkoxy ethylene copolymer, and the like may be used. These may be used independently, or two or more these material may be mixed to be used. Further, fillers, such as inorganic fibers, may be combined with these to be used.

The gasket may contain, e.g., rubber material. The gasket may be constituted by a single layer containing the rubber material, or may be constituted by a multilayer, i.e., a rubber material layer and a fluororesin layer. As the rubber material, a butyl rubber (isobutylene-isoprene copolymer) (IIR) is preferable. Stable elasticity may be obtained by peroxide crosslinking or resin crosslinking. Thus, the butyl rubber may obtain sealing repulsive force stably. Further, the butyl rubber has lower gas permeability and higher insulation than other rubber materials. Therefore, performance of the electrochemical device can be maintained high even for long-term storage.

As a material of the fluororesin layer, PTFE (polytetrafluoroethane), PVDF (polyvinylidene fluoride), PFA (perfluoroalkoxy alkane), ETFE (ethylene-tetrafluoroethylene copolymer), and FEP (perfuluoroethylene-propylene copolymer) are preferable. When the multilayer structure, i.e., the butyl rubber layer and the fluororesin layer are formed, in order to obtain good adhesion in an interface between the rubber material layer and the fluororesin layer, it is preferred that a surface on a butyl rubber layer side of the fluororesin layer is roughed, and then compression molding is performed in the state where adhesion with the butyl rubber layer is kept high. Herein, corona processing, plasma processing, sodium processing, application of organic solvent in which active sodium is dissolved, or the like is applied to the surface on the butyl rubber layer side to be roughed.

The compression molding is performed for a monolayer, i.e., the butyl rubber layer only, or a multilayer of the fluororesin and the butyl rubber layer. A part of the molded sheet is punched to obtain an individual piece of the gaskets, and simultaneously, a tapered surface of the gasket may be formed in a part of the butyl rubber layer during the punching operation. Broken surface 13k of the butyl rubber layer formed in a part of tapered surface provides the gasket with higher productivity.

### Current Collector Rod

As a material of the current collector rod, copper, aluminum, stainless steel, iron, nickel, palladium, gold, silver, or platinum may be employed. These may be used as a single material, or as an alloy containing two or more kinds of these materials.

An outer diameter of the current collector rod is determined appropriately in consideration of, e.g., a size of a battery, strength of the current collector rod, and processability. A portion of the current collector rod to be inserted into the through-hole of the gasket may have an outer diameter ranging, e.g., from 0.5 mm to 50 mm, and may have an outer diameter ranging from 0.5 mm to 10 mm. In the case that the battery is a small battery such as a pin type of battery, the portion of the current collector rod to be inserted into the through-hole of the gasket may have an outer diameter ranging from 1 mm to 6 mm, and may have an outer diameter ranging from 1 mm to 4 mm.

### Tubular Case

As a material of the tubular case, silver, copper, iron, nickel, palladium, gold, platinum, aluminum, or stainless steel are employed. A thickness of the tubular case can be set appropriately. However, in consideration of intensity or processability, the thickness may range from 50 μm to 500 μm, and may range from 100 μm to 300 μm.

FIG. 4 is a front view of a partially cross-sectioned lithium primary battery of a cylinder type in accordance with the embodiment of the present disclosure. In FIG. 4, lithium primary battery 10 includes tubular case 11 of a cylindrical type, electrode assembly 12 of a would type accommodated in tubular case 11, and gasket 13 sealing tubular case 11. Electrode assembly 12 of the wound type includes current collector rod 14, negative electrode 15, positive electrode 16, and separator 17 that separates negative electrode 15 from positive electrode 16. Electrode assembly 12 of the wound type mentioned above contacts a nonaqueous electrolyte.

Current collector rod 14 is electrically connected to negative electrode 15 at a winding start position (innermost circumference) of electrode assembly 12 of the wound type. One end of current collector rod 14 is inserted into through-hole 13h of gasket 13. Reduced-diameter portion 35 closes an end on an opening of tubular case 11, thereby sealing the opening of tubular case 11 with gasket 13. One end of current collector rod 14 serving as current collector rod end 32 is exposed to the outside of tubular case 11, and used as an external negative electrode terminal of lithium primary battery 10.

Positive electrode 16 is wound at an outermost circumference of electrode assembly 12 of the wound type. In positive electrode 16 at the outermost circumference, a positive electrode current collector (not shown) is exposed, and contacts an inner circumference of tubular case 11 so as to apply pressure to the inner circumference. Tubular case 11 is thus electrically connected to positive electrode 16. Insulation cover 34 is provided on an outer surface of tubular case 11, and a region of outer surface of tubular case 11 where insulation cover 34 is not provided is used as an external positive electrode terminal of lithium primary battery 10. Insulation cap 33 is provided on the other end of current collector rod 14 so as not to prevent a short circuit between tubular cases 11 and current collector rod 14.

### INDUSTRIAL APPLICABILITY

An electrochemical device of the present disclosure maintains high sealing performance even for long-term use, and is suitably applicable to, e.g., a main power source of various kinds of meters and a memory backup power source.

### REFERENCE MARKS IN THE DRAWINGS

10 lithium primary battery of a pin type (electrochemical device)
11 tubular case
12 electrode assembly of a winding type
13, 23 gasket
13a bottom surface (first bottom surface)
13b bottom surface (second bottom surface)
13c outer circumferential side surface
13d tapered surface
13e second tapered surface
13f compressed portion
13h through-hole
13k broken surface
13p axis
131 projecting portion
132 uneven surface
14 current collector rod
15 negative electrode
16 positive electrode
17 separator
31 curl portion
32 current collector rod end
33 insulation cap
34 insulation cover
35 reduced-diameter portion
100 molded sheet
102 connecting portion

1. An electrochemical device comprising:
an electrode assembly including a positive electrode, a negative electrode, and a separator provided between the positive electrode and the negative electrode;
a tubular case accommodating the electrode assembly therein, the tubular case having a bottom closed and an opening; and
a gasket sealing the opening of the tubular case, wherein
the gasket has a tubular shape with a through-hole extending along an axis, the gasket having an outer circumferential side surface extending in an axial direction along the axis, a first bottom surface connected to one end of the outer circumferential side surface, and a second bottom surface connected to another end of the outer circumferential side surface, the through-hole having one end opening at the first bottom surface and another end opening at the second bottom side surface,
the first bottom surface of the tubular shape is continuously connected to the outer circumferential side surface of the tubular shape via a first tapered surface of the gasket inclining with respect to the outer circumferential side surface,
a part of the gasket on the outer circumferential side surface is compressed with a portion of an outer circumference of the tubular case having a diameter locally reduced to constitute a compressed portion, and
at least a part of the tapered surface is a rough surface having larger surface roughness than the portion of the outer circumferential side surface of the compressed portion.

2. The electrochemical device according to claim 1, wherein
the tapered surface has a broken surface of the gasket, and
the rough surface of the first tapered surface includes the broken surface.

3. The electrochemical device according to claim 1, wherein a ratio h1/h2 of h1 to h2 ranges from 0.04 to 0.43, where h1 is a maximum height of the first tapered surface with respect to the first bottom surface of the tubular shape in the axial direction, and h2 is a height of the second end of the outer circumferential side surface with respect to the first bottom surface of the tubular shape in the axial direction.

4. The electrochemical device according to claim 1, wherein a ratio h2/R of h2 to R is more than or equal to 0.18 and less than or equal to 1.6, where h2 is a height of the second end of the outer circumferential side surface with respect to the first bottom surface of the tubular shape in the axial direction, and R is an outer diameter of the outer circumferential side surface.

5. The electrochemical device according to claim 1, wherein the gasket includes a projecting portion provided on a bottom surface out of the first bottom surface and the second bottom surface of the tubular shape which does not face the electrode assembly, the projecting portion having an annular shape extending to surround the through-hole.

6. The electrochemical device according to claim 1, wherein an uneven surface or a matte surface is provided in at least one of the first bottom surface and the second bottom surface of the tubular shape of the gasket.

7. The electrochemical device according to claim 6, wherein
the uneven surface is formed in the at least one of the first bottom surface and the second bottom surface of the tubular shape of the gasket, and
the first tapered surface is continuously connected to a recess in the uneven surface.

8. The electrochemical device according to claim 1, wherein a height of a center of gravity of the gasket with respect to the first bottom surface in the axial direction is positioned in a range from 0.45·H to 0.498·H, where H is a maximum distance between the first bottom surface and the second bottom surface of the tubular shape of the gasket.

9. The electrochemical device according to claim 1, wherein the second bottom surface of the tubular shape of the gasket is continuously connected to the second end of the outer circumferential side surface via a second tapered surface of the gasket inclining with respect to the outer circumferential side surface.

10. The electrochemical device according to claim 9, wherein an entire shape of the gasket is symmetrical with respect to a surface perpendicular to the axis.

11. The electrochemical device according to claim 1, wherein the gasket is made of a butyl rubber or includes a laminated structure including a fluororesin layer and layer.

12. A method of manufacturing an electrochemical device, the method comprising:
providing a gasket having a tubular shape with a through-hole therein, the gasket having a bottom surface of the tubular shape continuously connected to an outer circumferential side surface of the tubular shape via a tapered surface of the gasket inclining with respect to the outer circumferential side surface, one end of the through-hole opening at the bottom surface;
providing a tubular case with a closed bottom, the tubular case having an opening therein; and
sealing the opening of the tubular case by inserting the gasket into the opening of the tubular case such that, while the tubular case accommodating the electrode assembly and an electrolyte therein, the bottom surface of the gasket faces the electrode assembly, the electrode assembly including a positive electrode, a negative electrode, and a separator provided between the positive electrode and the negative electrode, wherein
said providing the gasket comprises:
providing a molded sheet including a connecting portion and a plurality of gaskets including the gasket, the plurality of gaskets being arranged one-dimensionally or two-dimensionally such that the plurality of gaskets are connected to one another via the connecting portion, the connecting portion having a surface continuously connected to the bottom surface of the gasket; and
separating the gasket from the molded sheet by breaking the connecting portion such that a broken surface inclining with respect to the outer circumferential side surface is formed.
